(19) United States
(12) Patent Application Publication
(10) Pub. No.: US 2026/0245230 A1
(43) Pub. Date: Aug. 20, 2026

(54) IMAGE PROCESSING DEVICE

(71) Applicant: FANUC CORPORATION, Minamitsuru-gun, Yamanashi (JP)

(72) Inventor: Taiki KATAGIRI, Yamanashi (JP)

(73) Assignee: FANUC CORPORATION, Minamitsuru-gun, Yamanashi (JP)

(21) Appl. No.: 19/159,488

(22) PCT Filed: Mar. 3, 2023
(86) PCT No.: PCT/JP2023/008137

§ 371 Date: Aug. 25, 2025

(51) Int. Cl. G06T 7/62; G06V 10/20; G06V 10/28

(52) U.S. Cl. CPC G06T 7/62; G06V 10/255; G06V 10/28

(57) ABSTRACT

Provided is an image processing device comprising: an image acquisition unit that acquires, from a visual sensor, image information obtained as a result of the visual sensor capturing an image within a field of view; a detection unit that performs a detection process to detect an object from the image information on the basis of information representing object features; a blob extraction unit that uses the image information as a basis for extracting a region identified as a blob; an area calculation unit that calculates the area of the object detected by the detection unit as a first area and calculates the area of the region identified as the blob as a second area; and a determination unit that determines whether or not an undetected object that was not detected in the detection process is present in the image information, on the basis of a comparison of the first and second areas.

### FIELD

The present disclosure relates to an image processing device. cl BACKGROUND

A robot system that can detect a target object with a visual sensor and perform an operation, such as pick-up of the target object, is known.

For example, PTL 1 describes a robot system including a robot and an image capture device equipped on the robot and executing a task of transporting piled objects from one container to another container. PTL 2 describes a handling system for workpiece transfer used when applying grinder finishing to a plate-like metallic workpiece acquired by fusion cutting or the like.

### CITATION LIST

### PATENT LITERATURE

[PTL 1] Japanese Unexamined Patent Publication (Kokai) No. 2020-21212 A
[PTL 2] Japanese Unexamined Patent Publication (Kokai) No. 2007-021635 A

### SUMMARY

### Technical Problem

In a system detecting a target object with a visual sensor and performing picking-up of a target object and the like by a robot, part of target objects may remain in an undetected state in detection processing by the visual sensor due to various causes. When such non-detection occurs, an image at occurrence of the non-detection is stored, the cause of the non-detection is investigated, and the detection processing is improved. However, whether non-detection has occurred is generally determined by human visual inspection. A technology that can automatically and reliably determine whether non-detection is occurring in the detection processing is desired.

### Solution to Problem

An embodiment of the present disclosure is an image processing device including: an image acquisition unit configured to acquire, from a visual sensor, image information acquired by the visual sensor by capturing an image of the inside of a visual field; a detection unit configured to perform detection processing of detecting a target object from the image information, based on information representing a feature of the target object; a blob extraction unit configured to extract a region specified as a blob, based on the image information; an area calculation unit configured to calculate the area of the target object detected by the detection unit as a first area and calculate the area of a region specified as the blob as a second area; and a determination unit configured to determine whether an undetected object not detected in the detection processing exists in the image information, based on a comparison between the first area and the second area.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including an image processing device according to an embodiment.

FIG. 2 is a diagram illustrating a functional block diagram related to the image processing device and a robot teaching device according to a first embodiment.

FIG. 3 is a flowchart illustrating non-detection determination processing according to the first embodiment.

FIG. 4A is an example of a captured image in which four target objects are captured.

FIG. 4B is a diagram illustrating a state of information indicating a detection result being added to the captured image in which the four target objects are captured.

FIG. 5 is a diagram illustrating a binarized image acquired by performing binarization processing on the captured image in FIG. 4A.

FIG. 6 is a diagram illustrating a comparison between the area of an extracted blob and the area of regions of detected target objects.

FIG. 7 is a diagram illustrating an example of a UI screen according to the first embodiment.

FIG. 8 is a diagram illustrating a functional block diagram related to an image processing device and a robot teaching device according to a second embodiment.

FIG. 9 is a flowchart illustrating non-detection determination processing according to the second embodiment.

FIG. 10 is a diagram illustrating an example of a UI screen according to the second embodiment.

### DESCRIPTION OF EMBODIMENTS

Next, embodiments of the present disclosure will be described with reference to the drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

A visual sensor herein is a two-dimensional camera acquiring a two-dimensional image, a three-dimensional sensor acquiring three-dimensional position information of a target, or a device having the functions of both a two-dimensional camera and a three-dimensional sensor. The visual sensor provides image information (e.g., a two-dimensional image or a three-dimensional point cloud) of a target an image of which is captured inside the visual field. Detection processing herein represents processing of detecting a target object in an image by a technique such as pattern matching, based on known feature information of the target object. A term blob herein represents a massive region without a particularly defined shape that may be extracted by applying predetermined image processing to image information.

### First Embodiment

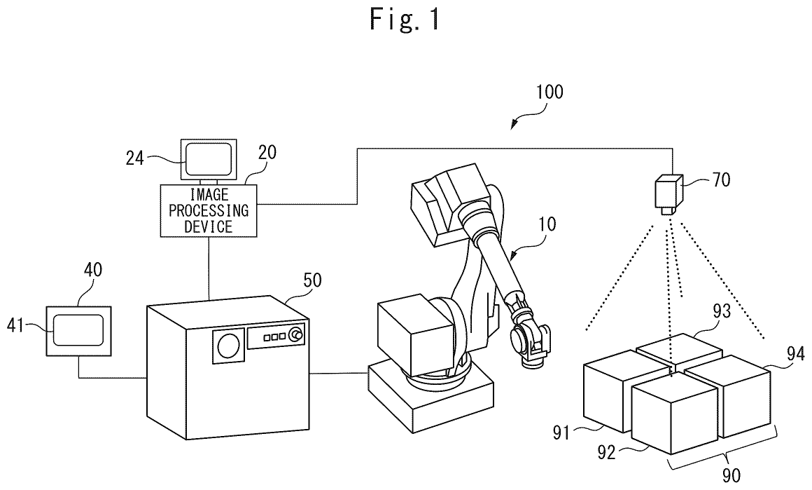

FIG. 1 is a diagram illustrating a configuration of a robot system including an image processing device according to an embodiment. Image processing device 20 has a function of controlling visual sensor 70 and processing an image captured by visual sensor 70. As illustrated in FIG. 1, robot system 100 includes robot 10, robot controller 50 controlling robot 10, teaching device 40 connected to robot controller 50, visual sensor 70, and image processing device 20. For example, robot system 100 can detect, by visual sensor 70, target object 90 arranged in a work region and handle target object 90 with a hand (unillustrated) equipped on robot 10.

While robot 10 according to the present embodiment is a vertical articulated robot, another type of robot, such as a parallel link robot or a dual-arm robot, may be used depending on the purpose of the work. Robot 10 can execute desired work with an end effector attached to the wrist.

Visual sensor 70 has a function as a two-dimensional camera capturing a gray-scale image and/or a color image. It should be noted that while FIG. 1 illustrates an example of visual sensor 70 being a fixed camera fixed in a workspace, visual sensor 70 may be equipped on the wrist of robot 10.

Image processing device 20 holds model patterns of target objects 90 (91 to 94) and can execute detection processing of detecting a target object by pattern matching between an image of the target object in the captured image and the model pattern. Visual sensor 70 is assumed to be calibrated, and image processing device 20 is assumed to hold calibration data defining a relative positional relation between visual sensor 70 and robot 10. Thus, a position on a two-dimensional image captured by visual sensor 70 can be transformed into a position in a coordinate system fixed to the workspace (e.g., a robot coordinate system). A situation in which detection unit 123 cannot correctly detect a target object on an image in which the target object is captured may occur due to various causes such as an arrangement state of the target objects and lighting in the workspace. As will be described later, image processing device 20 can provide a function of automatically determining whether an object determined to be undetected exists in detection of a target object by the detection processing.

While image processing device 20 is configured to be a device separate from robot controller 50 in FIG. 1, the function as image processing device 20 may be embedded in robot controller 50.

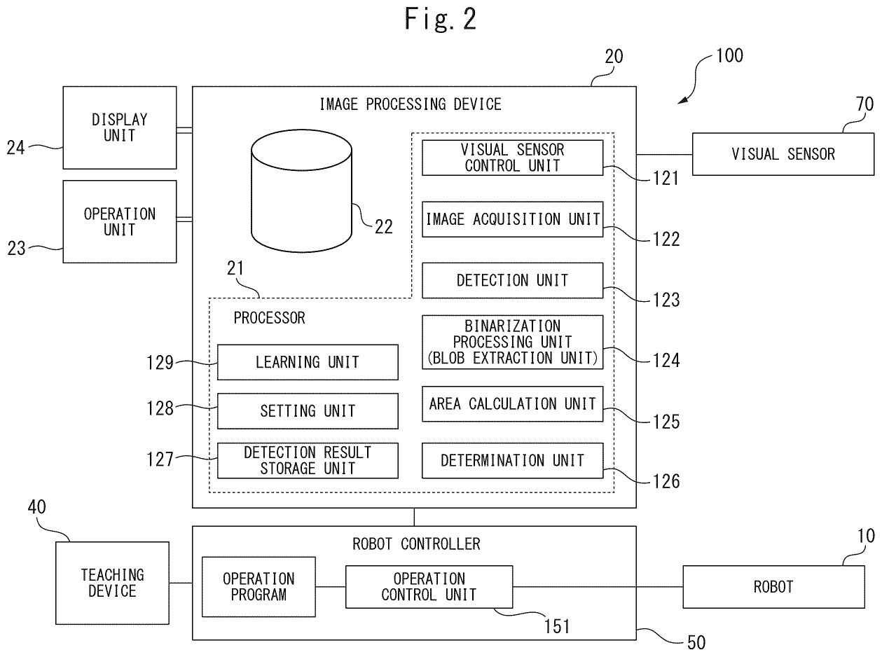

Image processing device 20 may have a hardware configuration as a common computer including processor 21, a memory (e.g., a ROM, a RAM, or a nonvolatile memory), storage device 22, operation unit 23, display unit 24, an input-output interface, a network interface, and the like (see FIG. 2). Image processing device 20 can be configured with a personal computer (PC) or various other information processing devices. For example, display unit 24 is a liquid crystal display. For example, operation unit 23 may include various pointing devices such as a keyboard and a mouse.

Robot controller 50 controls the operation of robot 10 in accordance with an operation program or a command from teaching device 40. Robot controller 50 may have a hardware configuration as a common computer including a processor, a memory (e.g., a ROM, a RAM, or a nonvolatile memory), a storage device, an operation unit, an input-output interface, a network interface, and the like.

Teaching device 40 is used as an operation terminal for performing teaching (program creation) of robot 10 and various types of settings. Teaching device 40 may be a teach pendant or may be configured with a tablet computer or the like. Teaching device 40 may have a hardware configuration as a common computer including a processor, a memory (e.g., a ROM, a RAM, or a nonvolatile memory), a storage device, an operation unit, display unit 41, an input-output interface, a network interface, and the like. For example, display unit 41 is configured with a liquid crystal display.

FIG. 2 illustrates a functional block diagram related to image processing device 20 and robot controller 50. As illustrated in FIG. 2, robot controller 50 includes operation control unit 151. Operation control unit 151 controls the operation of robot 10 in accordance with the operation program or a command from teaching device 40. Robot controller 50 includes a servo control unit (unillustrated) executing servo control on a servomotor on each axis in accordance with a command to the axis generated by operation control unit 151.

As illustrated in FIG. 2, image processing device 20 includes visual sensor control unit 121, image acquisition unit 122, detection unit 123, binarization processing unit 124, area calculation unit 125, and determination unit 126. Image processing device 20 may further include detection result storage unit 127, setting unit 128, and learning unit 129. As illustrated in FIG. 2, the functional blocks may be provided by execution of software by processor 21.

Visual sensor control unit 121 controls the operation of visual sensor 70. For example, visual sensor control unit 121 can receive an operation command for visual sensor 70 from robot controller 50 and control visual sensor 70. Image acquisition unit 122 acquires image information acquired by capturing an image of the inside of the visual field by visual sensor 70. Image acquisition unit 122 according to the present embodiment acquires a two-dimensional image from visual sensor 70.

Detection unit 123 can execute detection processing of detecting a target object in image information (a two-dimensional image in this case) acquired from visual sensor 70, based on known feature information of the target object. For example, image processing device 20 holds model data of a target object in storage device 22. Detection unit 123 has model data of a target object and can detect the target object in an image by the matching method using the model data. For example, detection unit 123 detects a target object on a captured image by comparing an edge feature of model data with an edge feature of the target object on the image. Thus, detection unit 123 can specify a region where the target object exists on the image.

Binarization processing unit 124 can execute binarization processing on an image. Binarization processing unit 124 can extract a region having a specific pixel value (e.g., 1) in a binarized image as a blob. In other words, binarization processing unit 124 functions as a blob extraction unit that can extract a region specified as a blob.

Area calculation unit 125 can calculate the area of a target object detected by detection unit 123 (the area is also referred to as a first area) and can calculate the area of a region specified as a blob (the area is also referred to as a second area). As an example, area calculation unit 125 can calculate the total sum of the areas of regions of target objects detected by detection unit 123 on an image as the first area. Further, area calculation unit 125 can calculate the total sum of the areas of regions of blobs extracted by the binarization processing unit as the second area. Area calculation unit 125 may calculate the areas, based on a coordinate system set on the image.

Determination unit 126 can determine whether an object not detected by detection unit 123 (e.g., an undetected target object) exists in an image, based on the comparison between the first area and the second area that are calculated by area calculation unit 125.

Detection result storage unit 127 provides a function of storing an image and information about the detection result into, for example, storage device 22 when an undetected target object exists. Setting unit 128 provides a function for performing various types of settings related to the operation of image processing device 20. For example, setting unit 128 can provide a user interface (UI) accepting setting of parameters used for execution of processing by binarization processing unit 124 and determination unit 126. Setting unit 128 can control display unit 24 to display the UI and accept user input to the UI through operation unit 23.

Processing by image processing device 20 for determining whether an object determined to be undetected in the detection processing by detection unit 123 exists in a captured image (hereinafter also referred to as non-detection determination processing) will be described below.

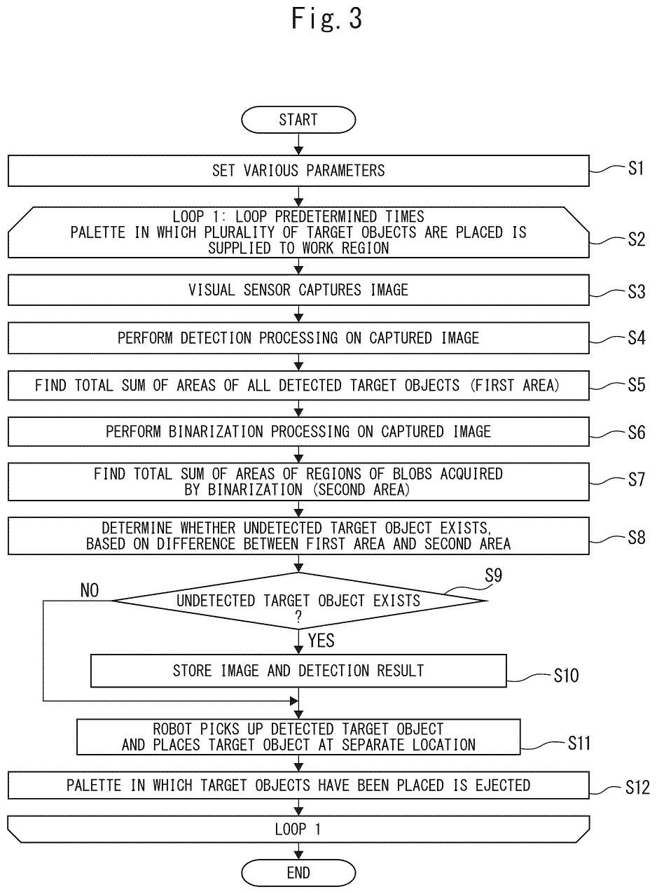

FIG. 3 is a flowchart illustrating the non-detection determination processing. The non-detection determination processing is executed under the control of processor 21 of image processing device 20. A situation in which four target objects 91 to 94 are arranged in a work region is assumed as illustrated in FIG. 1. Visual sensor 70 is arranged in such a way that the work region including four target objects 91 to 94 is included in the image capture range, and the non-detection determination processing is executed on an image captured in the situation.

First, image processing device 20 (setting unit 128) accepts user setting of various parameters (step S1). The parameters to be set include one or more of the following parameters related to determination of non-detection, in addition to parameters (e.g., a detection score) used in the detection processing by detection unit 123.
(1) a threshold value when the binarization processing is performed
(2) a region being a target of the binarization processing on a captured image
(3) a threshold value for determining the existence of non-detection

For example, when each pixel of a captured image has a brightness value as a pixel value, a “threshold value when the binarization processing is performed” represents a threshold value for determining a brightness value a value greater than which causes a corresponding binarized pixel value to be set to 1. A user can set a desired threshold value considering a lighting situation in the workspace, the property of a target object, and the like. A default value may be preset as the threshold value. It should be noted that, based on the bit count of a pixel value (a brightness value) of one pixel in an image, setting unit 128 may automatically set the “threshold value when the binarization processing is performed” to, for example, a value about half of the maximum brightness value represented by the bit count.

A “region being a target of the binarization processing on a captured image” is a region being a target of the binarization processing performed by binarization processing unit 124 on the captured image. By making a region being a target of the binarization processing specifiable, for example, a user can avoid a situation in which peripheral equipment appears on a binarized image as a blob. Further, by making a region being a target of the binarization processing specifiable, reduction in the load on image processing and speedup of the processing can be achieved.

A “threshold value for determining the existence of non-detection” is a threshold value used when determination unit 126 determines whether non-detection exists. Determination unit 126 determines that an undetected target object exists when the difference between the second area and the first area is equal to or greater than the threshold value. For example, the threshold value for determining the existence of non-detection may be half the area of one target object. It should be noted that when the area of one target object is known, setting unit 128 may automatically set the threshold value for determining the existence of non-detection to half the known area of the target object. When an object smaller than a target object appears in a binarized image, the threshold value for determining the existence of non-detection may be set to a relatively large value (e.g., a value greater than half the area of one target object) so that such an object is not determined as an undetected target object, from the viewpoint of determining the existence of an undetected target object.

Next, a plurality of target objects are supplied to the work region of robot 10 and at the same time inside the visual field of the visual sensor (step S2). The target objects may be placed in the work region in a state of being lined up as illustrated in FIG. 1 or may be supplied in a state of a plurality of target objects being placed in a palette (unillustrated). Step S2 in FIG. 2 describes that a plurality of target objects are supplied in a palette as an example. In this stage, target objects 91 to 94 are placed in the work region of robot 10 as illustrated in FIG. 1 as an example. A series of processing operations from step S2 to step S12 is repeatedly executed a predetermined number of times as loop processing. In other words, processing in steps S3 to S11 with the target objects placed in the work region is repeatedly executed the predetermined number of times.

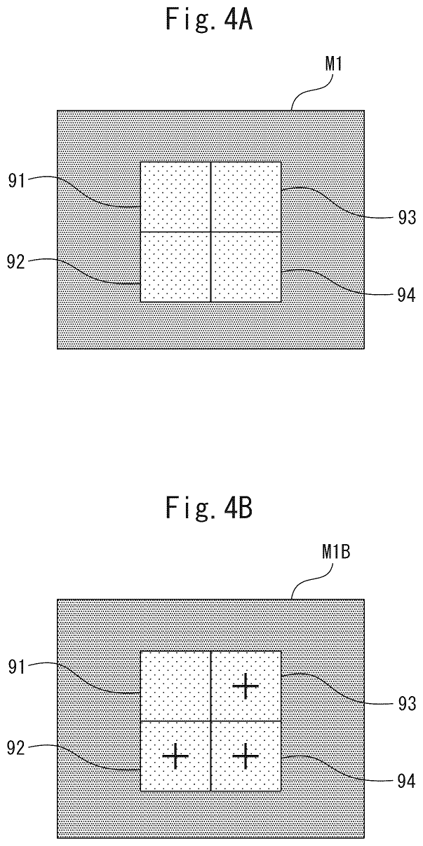

Next, visual sensor 70 performs image capture in accordance with a command from visual sensor control unit 121 (step S3). Then, detection unit 123 executes the detection processing on the captured image (step S4). It is assumed that the captured image is image M1 in which four target objects 91 to 94 are captured as illustrated in FIG. 4A. It is assumed that target objects detected in the detection processing by detection unit 123 are three target objects 92 to 94. FIG. 4B illustrates image M1B in which a sign “+” indicating detection is superposed on each of target objects 92 to 94 detected by detection unit 123. By viewing image M1B being the detection result, a user can recognize that target objects that can be detected by the current detection parameter are target objects 92 to 94 and that target object 91 is not detected.

Next, area calculation unit 125 finds the total sum of the areas of the regions of the target objects detected on the captured image by detection unit 123 (step S5). In this case, area calculation unit 125 calculates the sum of the areas of the regions of three target objects 92 to 94 on image M1 as the first area.

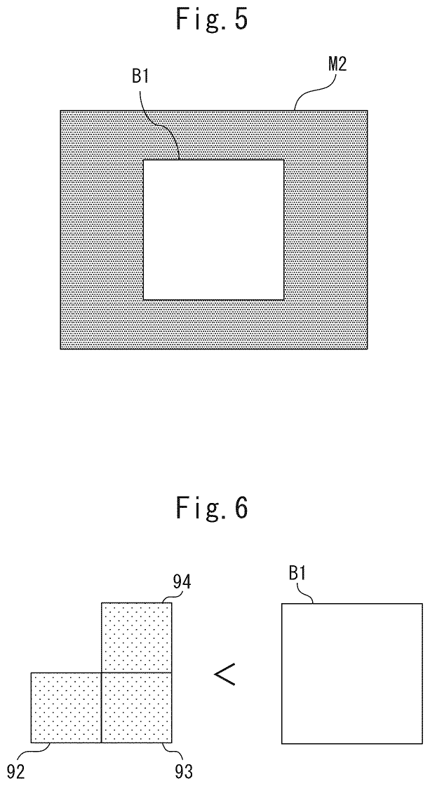

Next, binarization processing unit 124 executes the binarization processing on the captured image by using the threshold value set in step S1 for performing the binarization processing (step S6). When a “region being a target of the binarization processing on a captured image” is specified, binarization processing unit 124 performs the binarization processing on the region specified on the captured image. It is assumed that the “region being a target of the binarization processing on a captured image” is specified for the entire region of the captured image. Target objects 91 to 94 are relatively brightly captured, and a region of the floor surface or the bottom surface of the palette is darkly captured in image M1. By performing the binarization processing on image M1, binarized image M2 as illustrated in FIG. 5 can be acquired. In the example of image M2, a region where four target objects 91 to 94 exist is extracted as a region of blob B1 having a value 1 as a pixel value. It should be noted that a region having 0 as a pixel value is the region of the floor surface or the bottom surface of the palette in this case.

Next, area calculation unit 125 finds the total sum of the areas of regions extracted as blobs in the binarized image as the second area (step S7). The area of the region of blob B1 is found as the second area in the case of image M2. Then, determination unit 126 determines whether an undetected target object exists, based on the difference between the second area and the first area (step S8). For example, when the difference between the second area and the first area is equal to or greater than the “threshold value for determining the existence of non-detection” set in step S1, determination unit 126 determines that non-detection exists. In this case, as schematically illustrated in FIG. 6, the area of extracted blob B1 (the second area) is practically greater than the area of the regions of the detected target objects 92 to 94 (the first area) by the area of one target object. Accordingly, for example, by setting the value of about half the area of one target object to the “threshold value for determining the existence of non-detection,” the determination of whether non-detection exists can be suitably performed.

When an undetected target object exists (S9: YES), detection result storage unit 127 stores an image and information about the result of the detection processing as history information into, for example, storage device 22 (step S10). The detection result in this case may include a history image such as image M1B, a parameter used in the detection processing, and the detection processing result related to the target object determined to be undetected (e.g., a score value). The stored history information can be utilized for analysis of the cause of the non-detection and improvement of the detection processing. When an undetected target object does not exist (S9: NO), the processing advances to step S11.

Next, robot 10 executes a workpiece transfer operation of picking up the detected target objects and placing the target objects at a separate location in accordance with the operation program (step S11). Next, the palette in which the target objects have been placed is ejected (step S12). A series of processing operations from steps S2 to S12 (loop processing) is repeated on subsequently supplied target objects. When the loop processing is executed a predetermined number of times, the processing ends.

The non-detection determination processing described above enables automatic and reliable determination of whether non-detection exists in the detection processing by detection unit 123. When non-detection exists, history information including a history image and the like is automatically stored. Accordingly, the need for a user to determine whether non-detection has occurred by visual inspection is eliminated. Further, history information only at occurrence of non-detection can be efficiently stored. The history information accumulated by the non-detection determination processing can be utilized for analysis of the cause of non-detection and improvement of the detection processing.

For example, the aforementioned non-detection determination processing can be applied not only to the case of target objects being placed in the state of being lined up as illustrated in FIG. 1 but also to a situation in which target objects exist in a palette in a scattered state. Further, the aforementioned non-detection determination processing can be applied to a situation in which the number of supplied target objects is not always the same.

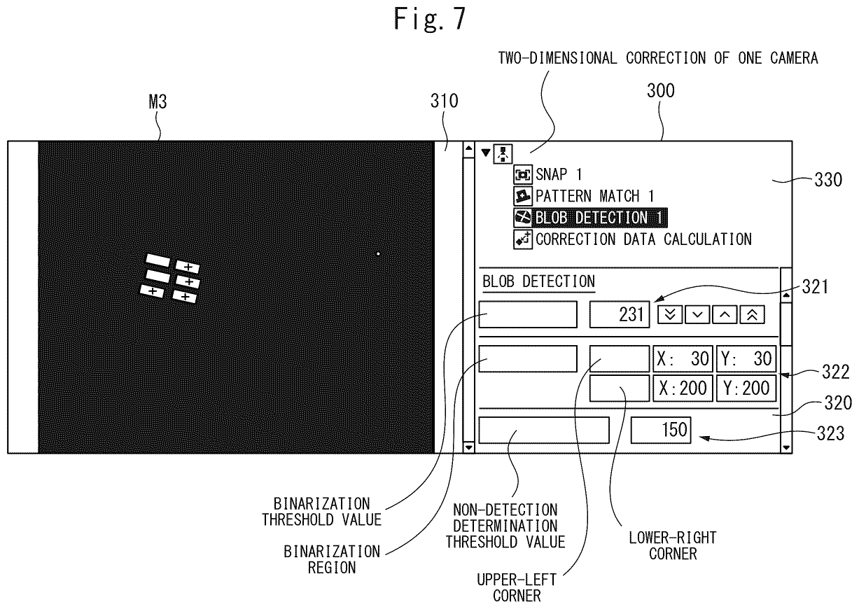

FIG. 7 illustrates an example of user interface (UI) screen 300 provided by setting unit 128. UI screen 300 accepts setting of various parameters in step S1 in the non-detection determination processing and is configured as a user interface for presenting an image representing a detection result. UI screen 300 includes image display region 310 and parameter setting region 320. UI screen 300 may include program display region 330 displaying program instructions related to image capture and image processing.

A captured image or a binarized image is displayed in image display region 310. Information indicating a detection result may be added to the image displayed in image display region 310.

Parameter setting region 320 may include at least one or more of
(1) input field 321 for inputting a threshold value when the binarization processing is performed,
(2) input field 322 for specifying a region being a target of the binarization processing on a captured image, and
(3) input field 323 for inputting a threshold value for determining the existence of non-detection.
   A user can execute the non-detection determination processing by inputting the parameters and performing a predetermined operation. When the non-detection determination processing is executed with the input parameters, a binarized image as part of the processing result may be displayed in image display region 310.

A numerical value as the threshold value when the binarization processing is performed can be input to input field 321. For example, coordinates (pixel values of the X- and Y-coordinates) of the upper-left corner and coordinates (pixel values of the X- and Y-coordinates) of the lower-right corner of a rectangular region can be input to input field 322 as a region being a target of the binarization processing. It should be noted that while a setting technique example of specifying a region being a target of the binarization processing by coordinate values has been described, a graphical user interface allowing the target region to be graphically specified on an image by using a pointing device may be provided. A numerical value as the threshold value for determining the existence of non-detection can be input to input field 323.

For example, a user can perform setting as follows through UI screen 300. For example, it is assumed that a range of the brightness value of a captured image is 0 to 255. In this case, for example, a user sets 231 as the “threshold value when the binarization processing is performed” (the threshold value for brightness) so that only a target object has a pixel value “1” after binarization. For example, it is assumed that the size and the area of one target object are 10 pixels by 30 pixels and 300 pixels, respectively. In this case, the user may set 150 pixels being half the area 300 pixels of one target object as the “threshold value for determining the existence of non-detection.”

FIG. 7 illustrates an example of image M3 after the binarization processing being displayed in image display region 310. In image M3, six target objects are extracted as blobs in a binarized image when the binarization processing is performed with the aforementioned setting example. Further, image M3 illustrates an example of a sign “+” indicating detection being added to four target objects out of the six target objects as information indicating a detection result. In other words, image M3 indicates that six target objects are extracted as blobs (bright regions), four of the target objects are detected in the detection processing, and two target objects are undetected.

Information about a result of the non-detection determination processing may be further displayed on UI screen 300. Examples of information about a result of the non-detection determination processing include existence of non-detection and the number of undetected target objects. For example, by using known information about the area of one target object, determination unit 126 can find the number of undetected target objects by calculating the ratio of the difference between the second area and the first area to the area of one target object. It should be noted that the area of one target object may be specifiable as a parameter in parameter setting region 320.

Thus, the user can set parameters and efficiently confirm an image after the binarization processing and a result of the non-detection determination processing through UI screen 300.

An example of accepting user setting of the threshold value when the binarization processing is performed and the threshold value for determining the existence of non-detection by the function of setting unit 128 and using the user set parameters in the non-detection determination processing has been described above. Image processing device 20 may further have a function of automatically setting at least one of the parameters. A function of acquiring a proper value of a parameter by learning will be described as the function of automatically setting at least one of the parameters. As illustrated in FIG. 2, image processing device 20 may include learning unit 129 acquiring, by learning, proper values of parameters including the threshold value when the binarization processing is performed and the threshold value for determining the existence of non-detection. The function of learning unit 129 will be described below.

As an example, learning unit 129 performs learning for acquiring a proper value of a parameter by machine learning. An example of learning a proper value of a parameter by supervised learning will be described. A technique of deep learning may be introduced into the learning.

The brightness and the contrast of an image in which a target object is captured may change due to various causes such as the brightness of the workspace even for the same target object. Accordingly, it can be considered that there is a correlation between a captured image and parameters (the threshold value when the binarization processing is performed and the threshold value for determining the existence of non-detection) when the existence of an undetected target object is successfully determined for the image. Learning unit 129 accumulates training data (actual data) including a captured image as input data and parameter values when non-detection is successfully determined for the image as truth data. For example, the training data may be stored into storage device 22.

Learning unit 129 performs learning by using the accumulated training data. For example, learning unit 129 causes an estimator to learn training data with a captured image as input data and parameters when non-detection is successfully determined for the image as truth data. For example, the estimator is configured with a neural network (NN) or a convolutional neural network (CNN). Thus, learning unit 129 can construct a learning model.

By inputting any captured image to the estimator (the learning model), parameters estimated to be suitable to the image can be acquired.

As described above, the first embodiment enables automatic and reliable determination of whether an undetected object not detected in the detection processing exists in a captured image.

### Second Embodiment

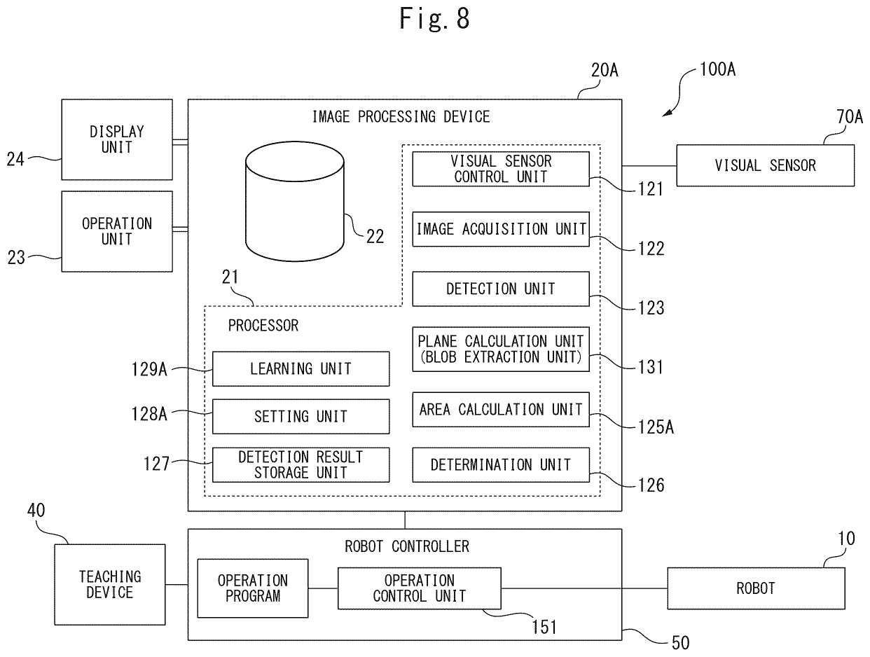

Image processing device 20A according to a second embodiment (see FIG. 8) will be described below. Image processing device 20A according to the second embodiment is configured to determine whether an undetected target object exists by using image information representing a three-dimensional point cloud of a target object. A configuration of robot system 100A including image processing device 20A according to the second embodiment is similar to that illustrated in FIG. 1.

FIG. 8 illustrates a functional block diagram of image processing device 20A according to the second embodiment. In FIG. 8, a functional block equivalent to a functional block in image processing device 20 according to the first embodiment is given the same sign, and description thereof is omitted or simplified. As illustrated in FIG. 8, image processing device 20A includes visual sensor control unit 121, image acquisition unit 122, detection unit 123, plane calculation unit 131, area calculation unit 125A, and determination unit 126. Image processing device 20A may further include detection result storage unit 127, setting unit 128A, and learning unit 129A. As illustrated in FIG. 8, the functional blocks may be provided by execution of software by processor 21.

Visual sensor 70A according to the present embodiment has a function as a three-dimensional sensor that can acquire a three-dimensional point cloud representing three-dimensional position information of an image capture target object, in addition to an image capture function of a two-dimensional image. For example, a time of flight (TOF) camera capturing a depth map by a time-of-flight method or a stereo camera including two cameras can be used as the three-dimensional sensor.

Image acquisition unit 122 acquires, from visual sensor 70A, image information including a two-dimensional image, and a three-dimensional point cloud of an image capture target object.

Plane calculation unit 131 can provide a function of extracting a point cloud in a specific height range from a three-dimensional point cloud as a plane. Since a three-dimensional point cloud includes three-dimensional position information of each point, a point cloud within the specific height range can be extracted as a plane. In other words, plane calculation unit 131 functions as a blob extraction unit that can extract a region specified as a blob in image information. For example, the “specific height range” is set by a user.

Area calculation unit 125A calculates the total sum of the areas of regions of target objects detected on an image by detection unit 123 as a first area. Area calculation unit 125A finds the total sum of the areas of planes calculated by plane calculation unit 131 as a second area. Then, determination unit 126 can determine whether non-detection exists in detection by the detection unit by comparing the first area with the second area.

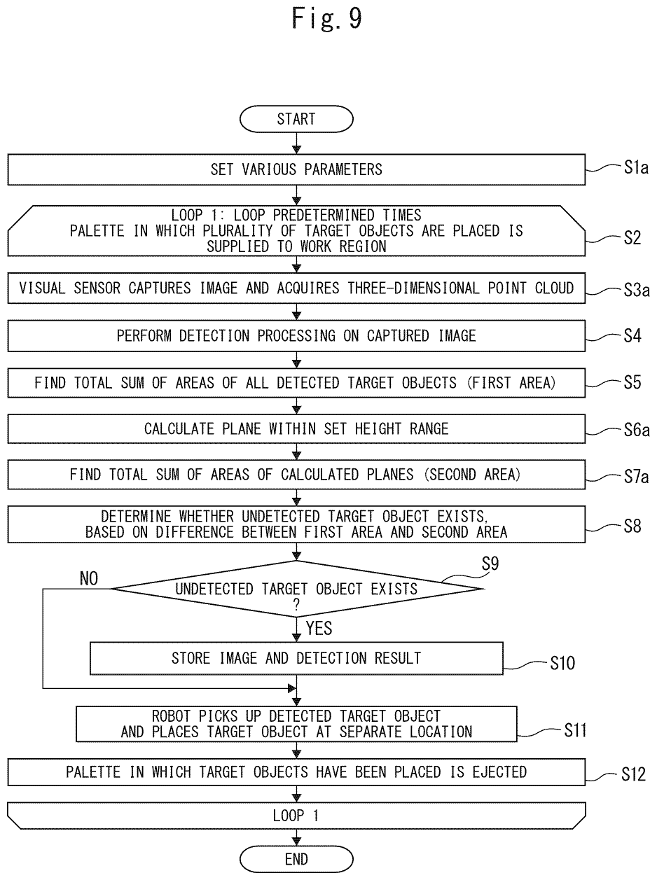

Non-detection determination processing executed by image processing device 20A according to the second embodiment will be described below. FIG. 9 is a flowchart of the non-detection determination processing according to the second embodiment. The non-detection determination processing is executed under the control of processor 21. It should be noted that, in FIG. 9, a step being the same processing as a step in the non-detection determination processing according to the first embodiment illustrated in FIG. 3 is given the same step number, and description thereof is omitted or simplified.

First, setting unit 128A accepts user setting of parameters used in the non-detection determination processing (step S1). The parameters to be set include one or more of the following parameters related to determination of non-detection in addition to parameters used in detection processing by detection unit 123 (e.g., a detection score).
(1) a height range of a three-dimensional point cloud for area finding
(2) a “region being a target of plane finding on a captured image”
(3) a threshold value for determining the existence of non-detection

A “height range of a three-dimensional point cloud for area finding” is a parameter specifying a height range for extracting a point cloud representing a plane from a three-dimensional point cloud. For example, a user can specify a suitable height range for extracting a region of a target object as a blob, based on the size (the height) of the target object. For example, a certain range including the height of a target object may be set as a “height range of a three-dimensional point cloud for area finding.” Setting unit 128A may automatically set a “height range of a three-dimensional point cloud for area finding,” based on model data of a target object.

A “region being a target of plane finding on a captured image” is a region on an image being a target of finding a plane from a three-dimensional point cloud. By making a “region being a target of plane finding on a captured image” specifiable, for example, a user can avoid a situation in which peripheral equipment is extracted as a blob by processing of finding a plane. Further, by making a “region being a target of plane finding on a captured image” specifiable, reduction in the image processing load and speedup of the processing can be achieved.

Next, a plurality of target objects are supplied to a work region of robot 10 and at the same time inside the visual field of the visual sensor (step S2). The target objects may be placed in the work region in a state of being lined up as illustrated in FIG. 1 or may be supplied in a state of a plurality of target objects being placed in a palette (unillustrated). Step S2 in FIG. 9 describes that a plurality of target objects are supplied in a palette as an example. In this stage, target objects 91 to 94 are placed in the work region of robot 10 as illustrated in FIG. 1 as an example.

Next, visual sensor 70A captures the inside of the visual field in accordance with a command from visual sensor control unit 121 and acquires an image and a three-dimensional point cloud (step S3a). Then, detection unit 123 executes the detection processing on the captured image, based on model data of the target objects (step S4). Area calculation unit 125A finds the total sum of the areas of regions of the target objects detected on the captured image by detection unit 123 as the first area (step S5).

Next, plane calculation unit 131 calculates a plane within a set height range, based on the “height range of a three-dimensional point cloud for area finding” specified by a user in step S1 (step S6a). For example, plane calculation unit 131 extracts a point cloud within the specified height range in the three-dimensional point cloud as a plane. When a “region being a target of plane finding on a captured image” is specified, plane calculation unit 131 extracts a plane in the specified region in an image represented by the three-dimensional point cloud.

Next, area calculation unit 125A finds the total sum of the areas of regions specified as planes in step S6a as the second area (step S7a). Then, determination unit 126 determines whether an undetected target object exists, based on the difference between the second area and the first area (step S8). When an undetected target object exists (S9: YES), detection result storage unit 127 stores a history image and the detection result as history information into, for example, storage device 22 (step S10).

Next, robot 10 executes workpiece transfer operation of picking up the detected target objects and placing the target objects at a separate location in accordance with the operation program (step S11). Next, the palette in which the target objects have been placed is ejected (step S12). A series of processing operations (loop processing) from step S2 to S11 is repeated on subsequently supplied target objects. When the loop processing is executed a predetermined number of times, the processing ends.

When the non-detection determination processing according to the present embodiment is executed on target objects 91 to 94 as illustrated in FIG. 1, captured image M1 as illustrated in FIG. 4A is also acquired, and image M1B of a detection result as illustrated in FIG. 4B is also acquired. By applying the processing of finding a plane to a three-dimensional point cloud, the same region as the region illustrated as blob B1 on image M2 in FIG. 5 may be extracted as a plane. Accordingly, whether non-detection exists in the detection processing by detection unit 123 can be automatically and reliably determined in the non-detection determination processing according to the present embodiment as well. Further, when non-detection exists, history information including a history image and the like is automatically stored. In other words, the non-detection determination processing according to the present embodiment can also provide effects similar to those provided by the non-detection determination processing according to the first embodiment.

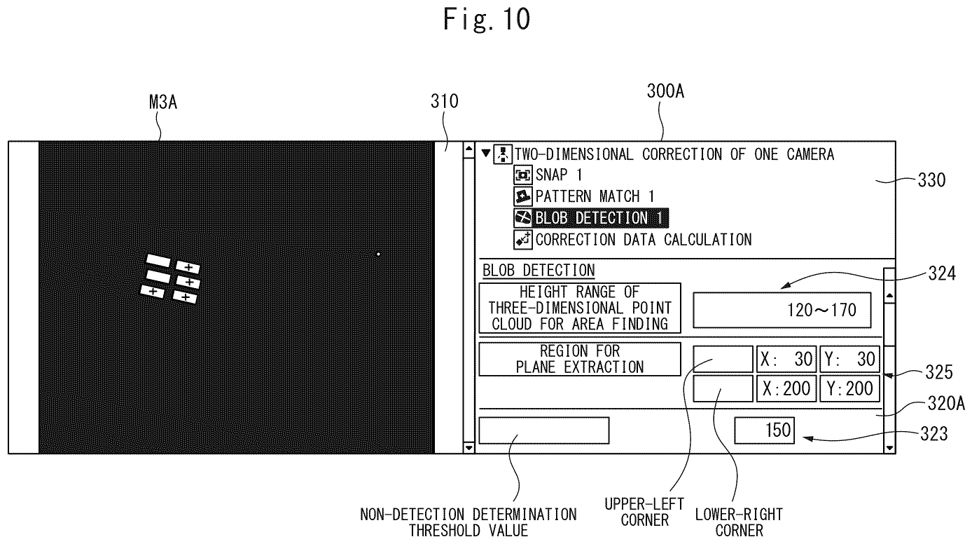

Setting unit 128A according to the second embodiment can also provide a UI screen having a function similar to that of UI screen 300 according to the first embodiment. FIG. 10 illustrates UI screen 300A provided by setting unit 128A. It should be noted that, in FIG. 10A, a part having the same function as that of the UI screen illustrated in FIG. 7 is given the same sign, and description thereof is omitted or simplified.

As illustrated in FIG. 10, UI screen 300A includes image display region 310, parameter setting region 320A, and program display region 330. Parameter setting region 320A according to the present embodiment may include at least one or more of
(1) input field 324 for specifying a “height range of a three-dimensional point cloud for area finding,”
(2) input field 325 for specifying a “region being a target of plane finding on a captured image,” and
(3) input field 323 for inputting a threshold value for determining the existence of non-detection.
   A user can execute the non-detection determination processing by inputting the parameters and performing a predetermined operation. When the determination processing is executed with the input parameters, an image as the processing result (image M3A in which a plane is extracted as a blob) may be displayed in image display region 310.

A “height range of a three-dimensional point cloud for area finding” can be numerically input to input field 324. Coordinates (pixel values of the X- and Y-coordinates) of the upper-left corner and coordinates (pixel values of the X- and Y-coordinates) of the lower-right corner of a rectangular region can be input to input field 325 as a region being a target of plane extraction. It should be noted that while a setting technique example of specifying a region being a target of plane extraction by coordinate values has been described, a graphical user interface allowing the target region to be graphically specified on an image by using a pointing device may be provided. A numerical value as a threshold value for determining the existence of non-detection can be input to input field 323.

Image M3A representing a blob extracted by finding a plane from a three-dimensional point cloud may be displayed in image display region 310 according to the present embodiment. A part indicated in white in image M3A is a part extracted from a three-dimensional point cloud as a region representing a plane within a set height range (blob).

Information about a result of the non-detection determination processing may be displayed on UI screen 300A. Examples of information about a result of the non-detection determination processing include existence of non-detection and the number of undetected target objects. For example, determination unit 126 can find the number of undetected target objects by calculating the ratio of the difference between the second area and the first area to the area of one target object by using known information about the area of one target object. It should be noted that the area of one target object may be specifiable in parameter setting region 320A as one of the parameters.

Thus, the user can set parameters and efficiently confirm an image after plane extraction and the result of the non-detection determination processing through UI screen 300A.

Learning unit 129A according to the present embodiment performs learning by a technique similar to that performed by learning unit 129 according to the first embodiment. Learning unit 129A executes the learning with training data including a captured image as input data and parameter values (a “height range of a three-dimensional point cloud for area finding” and a “threshold value for determining the existence of non-detection”) when the existence of an undetected target object is successfully determined for the image as truth data. By inputting any captured image to an estimator (a learning model), parameters (a “height range of a three-dimensional point cloud for area finding” and a “threshold value for determining the existence of non-detection) estimated to be suitable for the image can be acquired.

Thus, the second embodiment also enables automatic and reliable determination of whether an undetected object not detected in the detection processing exists in a captured image.

While an example of specifying a “height range of a three-dimensional point cloud for area finding” as a parameter for extracting a plane from a three-dimensional point cloud is described in the aforementioned embodiment, a “height of a three-dimensional point cloud for area finding” may be specified as a parameter for extracting a plane from the three-dimensional point cloud. In this case, plane calculation unit 131 may extract a point cloud having a height practically equal to the specified “height of a three-dimensional point cloud for area finding” from the three-dimensional point cloud as a plane. Alternatively, for example, plane calculation unit 131 may extract a point cloud within a range of a predetermined threshold value from the value of the “height of a three-dimensional point cloud for area finding” as a plane.

The non-detection determination processing according to each of the aforementioned embodiments is processing that may determine whether an object not being a target of the detection processing exists in the work region (the visual field of the visual sensor) to which target objects are supplied. For example, by setting the “threshold value for determining the existence of non-detection” to a relatively small value (e.g., a value sufficiently smaller than the area of one target object), existence of a relatively small unconfirmed object in a captured image (i.e., in the work region) can also be determined.

Each of the aforementioned embodiments describes a configuration example of the image processing device being arranged as a device separate from the robot controller in the robot system. A configuration of the function as the image processing device being integrally incorporated into the robot controller is a possible example. In this case, UI screen 300 and UI screen 300A may be provided on display unit 41 of teaching device 40. Alternatively, the function as the image processing device may be integrally incorporated into teaching device 40.

The functional blocks in the image processing devices illustrated in FIG. 2 and FIG. 8 may be provided by the processor in the image processing device executing various types of software stored in the storage device or may be provided by a configuration mainly based on hardware such as an application specific integrated circuit (ASIC).

Programs executing various types of processing according to the embodiments described above, such as the non-detection determination processing, can be recorded on various computer-readable recording media (e.g., semiconductor memories such as a ROM, an EEPROM, and a flash memory; a magnetic recording medium; and optical disks such as a CD-ROM and a DVD-ROM).

As described above, each embodiment enables automatic and reliable determination of whether an undetected object not detected in the detection processing exists in a captured image.

While the present disclosure has been described in detail, the present disclosure is not limited to each of the aforementioned embodiments. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above also holds when a numerical value or a mathematical expression is used in the description of the aforementioned embodiments.

The following Supplementary Notes are further disclosed with regard to the aforementioned embodiments and the modified examples thereof.

### Supplementary Note 1

An image processing device (20, 20A), including: an image acquisition unit (122) configured to acquire, from a visual sensor (70, 70A), image information acquired by the visual sensor by capturing an image of an inside of a visual field; a detection unit (123) configured to perform detection processing of detecting a target object from the image information, based on information representing a feature of the target object; a blob extraction unit (124, 131) configured to extract a region specified as a blob, based on the image information; an area calculation unit (125, 125A) configured to calculate an area of the target object detected by the detection unit (123) as a first area and calculate an area of a region specified as the blob as a second area; and a determination unit (126) configured to determine whether an undetected object not detected in the detection processing exists in the image information, based on a comparison between the first area and the second area.

### Supplementary Note 2

The image processing device (20, 20A) according to Supplementary Note 1, wherein the area calculation unit (125, 125A) is configured to calculate a total sum of areas of one or more target objects detected by the detection unit 123 as the first area and calculates a total sum of areas of one or more regions specified as the blobs as the second area.

### Supplementary Note 3

The image processing device (20) according to Supplementary Note 1 or 2, wherein the image information includes a two-dimensional image, the blob extraction unit (124) includes a binarization processing unit (124) configured to perform binarization processing on the two-dimensional image, the binarization processing unit (124) is configured to extract a region having a specific pixel value in an image after the binarization processing as a region specified as the blob, and the area calculation unit (125) is configured to calculate a total sum of areas of one or more regions each having the specific pixel value in the image after the binarization processing as the second area.

### Supplementary Note 4

The image processing device (20) according to Supplementary Note 3, further including a setting unit (128) configured to accept an operation of specifying at least one of a threshold value when the binarization processing is performed and a region being a target of the binarization processing in the two-dimensional image.

### Supplementary Note 5

The image processing device (20A) according to Supplementary Note 1 or 2, wherein the image information includes a three-dimensional point cloud, the blob extraction unit (131) includes a plane calculation unit (131) configured to extract a plane existing at a specific height or within a specific height range as a region specified as the blob from the three-dimensional point cloud, and the area calculation unit (125A) is configured to calculate a total sum of areas of one or more found planes as the second area.

### Supplementary Note 6

The image processing device (20A) according to Supplementary Note 5, further including a setting unit (128A) configured to accept an operation of specifying at least one of the specific height, the specific height range, and a region being a target of finding the plane in the three-dimensional point cloud.

### Supplementary Note 7

The image processing device (20, 20A) according to any one of Supplementary Notes 1 to 6, wherein the determination unit (126) is configured to determine that the undetected object exists when a difference between the second area and the first area is equal to or greater than a predetermined threshold value.

### Supplementary Note 8

The image processing device (20, 20A) according to any one of Supplementary Notes 1 to 7, wherein the determination unit (126) configured to determine a number of one or more undetected target objects not detected by the detection processing in the image information, based on information representing an area of the one target object.

### Supplementary Note 9

The image processing device (20, 20A) according to any one of Supplementary Notes 1 to 8, further including a detection result storage unit (127) configured to store the image information and information about a result of the detection processing when an undetected object is determined to exist by the determination unit (126).

### Supplementary Note 10

The image processing device (20, 20A) according to Supplementary Note 1, 2, 3, or 5, further including a setting unit (128, 128A) configured to accept an operation of specifying a threshold value for determination used for determination by the determination unit (126), wherein the determination unit (126) is configured to determine that the undetected object exists when a difference between the second area and the first area is equal to or greater than the specified threshold value for determination.

### Supplementary Note 11

The image processing device (20) according to Supplementary Note 3, further including a learning unit (129) configured to perform learning with training data including the image information and actual data related to at least one of a threshold value when the binarization processing unit performs the binarization processing and a threshold value for determination used for determination by the determination unit, and provide an estimated value of at least one of a threshold value to be applied to the binarization processing when the binarization processing is performed on any input image information and a threshold value for the determination.

### REFERENCE SIGNS LIST

10 Robot
20, 20A Image processing device
21 Processor
22 Storage device
23 Operation unit
24 Display unit
40 Teaching device
41 Display unit
50 Robot controller
70, 70A Visual sensor
100, 100A Robot system
90, 91 to 94 Target object
121 Visual sensor control unit
122 Image acquisition unit
123 Detection unit
124 Binarization processing unit
125, 125A Area calculation unit
126 Determination unit
127 Detection result storage unit
128, 128A Setting unit
129, 129A Learning unit
151 Operation control unit
300, 300A UI screen
310 Image display region
320, 320A Parameter setting region
330 Program display region
321 to 325 Input field

1. An image processing device comprising:
an image acquisition unit configured to acquire, from a visual sensor, image information acquired by the visual sensor by capturing an image of an inside of a visual field;
a detection unit configured to perform detection processing of detecting a target object from the image information, based on information representing a feature of the target object;
a blob extraction unit configured to extract a region specified as a blob, based on the image information;
an area calculation unit configured to calculate an area of the target object detected by the detection unit as a first area and calculate an area of a region specified as the blob as a second area; and
a determination unit configured to determine whether an undetected object not detected in the detection processing exists in the image information, based on a comparison between the first area and the second area.

2. The image processing device according to claim 1, wherein
the area calculation unit is configured to calculate a total sum of areas of one or more target objects detected by the detection unit as the first area and calculates a total sum of areas of one or more regions specified as the blobs as the second area.

3. The image processing device according to claim 1, wherein
the image information includes a two-dimensional image,
the blob extraction unit includes a binarization processing unit configured to perform binarization processing on the two-dimensional image,
the binarization processing unit is configured to extract a region having a specific pixel value in an image after the binarization processing as a region specified as the blob, and
the area calculation unit is configured to calculate a total sum of areas of one or more regions each having the specific pixel value in the image after the binarization processing as the second area.

4. The image processing device according to claim 3, further comprising
a setting unit configured to accept an operation of specifying at least one of a threshold value when the binarization processing is performed and a region being a target of the binarization processing in the two-dimensional image.

5. The image processing device according to claim 1, wherein
the image information includes a three-dimensional point cloud,
the blob extraction unit includes a plane calculation unit configured to extract a plane existing at a specific height or within a specific height range as a region specified as the blob from the three-dimensional point cloud, and
the area calculation unit is configured to calculate a total sum of areas of one or more found planes as the second area.

6. The image processing device according to claim 5, further comprising
a setting unit configured to accept an operation of specifying at least one of the specific height, the specific height range, and a region being a target of finding the plane in the three-dimensional point cloud.

7. The image processing device according to claim 1, wherein
the determination unit is configured to determine that the undetected object exists when a difference between the second area and the first area is equal to or greater than a predetermined threshold value.

8. The image processing device according to claim 1, wherein
the determination unit is configured to determine a number of one or more undetected target objects not detected by the detection processing in the image information, based on information representing an area of the one target object.

9. The image processing device according to claim 1, further comprising
a detection result storage unit configured to store the image information and information about a result of the detection processing when an undetected object is determined to exist by the determination unit.

10. The image processing device according to claim 1, further comprising
a setting unit configured to accept an operation of specifying a threshold value for determination used for determination by the determination unit, wherein
the determination unit is configured to determine that the undetected object exists when a difference between the second area and the first area is equal to or greater than the specified threshold value for determination.

11. The image processing device according to claim 3, further comprising
a learning unit configured to perform learning with training data including the image information and actual data related to at least one of a threshold value when the binarization processing unit performs the binarization processing and a threshold value for determination used for determination by the determination unit, and provide an estimated value of at least one of a threshold value to be applied to the binarization processing when the binarization processing is performed on any input image information and a threshold value for the determination.
